(19) United States
(12) Patent Application Publication
(10) Pub. No.: US 2022/0288720 A1
(43) Pub. Date: Sep. 15, 2022

(54) LASER PROCESSING METHOD AND LASER PROCESSING MACHINE

(71) Applicant: OFUNA ENTERPRISE Japan Co., Ltd., Tokyo (JP)

(72) Inventors: Kunio ARAI, Tokyo (JP); Yasuhiko KANAYA, Tokyo (JP); Izumi HATA, Tokyo (JP); Yasuhiko KITA, Tokyo (JP); Hidenori TATEISHI, Tokyo (JP)

(21) Appl. No.: 17/690,608

(22) Filed: Mar. 9, 2022

(30) Foreign Application Priority Data
Mar. 12, 2021 (JP) 2021-076798
Feb. 21, 2022 (JP) 2022-037566

(51) Int. Cl. B23K 26/06; B23K 26/38; B23K 26/04

(52) U.S. Cl. CPC B23K 26/0626; B23K 26/38; B23K 26/04; B23K 2101/42

(57) ABSTRACT

Provided is a laser processing method for performing laser processing on a printed circuit board by using a carbon dioxide laser oscillator that oscillates a laser by applying an RF pulse, including continuing laser oscillation by restarting an RF pulse application while a laser after completing the RF pulse application is output, cutting off the continuously oscillated laser for a desired time, and performing laser processing on the printed circuit board.

### BACKGROUND OF THE INVENTION

### Field of the Invention

The present invention relates to a laser processing method and a laser processing machine for a printed circuit board suitable for forming a blind hole (row blind hole. Hereinafter, simply referred to as a hole or a BH.) in an insulating layer (hereinafter, simply referred to as an insulating layer) formed of a resin containing a glass fiber or a filler as a reinforcement in a process of manufacturing a package board.

### Description of the Related Art

In a build-up printed circuit board in the related art, an insulating layer and a copper layer integrated with each other are laminated on a copper layer so as to sandwich the insulating layer between the copper layers. In addition, a hole of 40 to 120 μm has been processed with a laser for interlayer connection that couples the copper layer on a surface and a lower copper layer by plating.

First, a configuration of a laser processing machine in the related art will be described.

FIG. 9 is a configuration diagram of a two-head laser processing machine in the related art.

A carbon dioxide laser oscillator 1 (hereinafter, referred to as a laser oscillator 1) outputs a pulsed linearly polarized laser 2. A beam diameter adjustment device 3 disposed between the laser oscillator 1 and a beam splitter 4 is a device for adjusting an energy density of the laser 2, and adjusts the energy density of the laser 2 by changing an outer diameter of the laser 2 output from the laser oscillator 1. That is, the energy of the laser 2 before and after the beam diameter adjustment device 3 does not change. Therefore, since the laser 2 emitted from the beam diameter adjustment device 3 can be regarded as the laser 2 output from the laser oscillator 1, hereinafter, the laser oscillator 1 and the beam diameter adjustment device 3 are collectively referred to as a laser output device 1A. The beam diameter adjustment device 3 may not be used.

The beam splitter 4 is disposed between the beam diameter adjustment device 3 and a polarization conversion device 5A. The beam splitter 4 divides the laser 2 into a laser 2A and a laser 2B in two directions at right angles. The laser 2A is supplied to a first processing head A, and the laser 2B is supplied to a second processing head B. Here, since the first processing head A and the second processing head B have the same configuration, those having the same configuration (reference numerals 5 to 12) are distinguished by adding subscripts A and B. and only a case of the first processing head A will be described below.

The polarization conversion device 5A converts the linearly polarized laser 2A into a circularly polarized laser 6A. Note that the polarization conversion device 5A includes a reflected light blocking mechanism (details are omitted) that blocks the laser 6A reflected from a processed portion during processing, and has a function of preventing damage to the laser oscillator 1 by the laser 6A reflected from the processed portion. A plate 7A disposed between the polarization conversion device 5A and a galvano mirror 10Aa is made of a material (for example, copper) that does not transmit the laser 6A, and a plurality of apertures (window, in this case a circular through-hole) 8A are selectively formed at predetermined positions. The plate 7A is driven by a driving device (not illustrated) to position an axis of the selected aperture 8A coaxially with an axis of the laser 6A A galvano device 9A includes a pair of galvano mirrors 10Aa and 10Ab, is rotatable around a rotation shaft as indicated by arrows in the drawing, and can position a reflecting surface at an arbitrary angle. An fθ lens (condenser lens) 11A is held in a housing of a processing head A (not illustrated). The galvano mirrors 10Aa and 10Ab constituting the processing head A and the fθ lens 11A constitute an optical axis positioning device that positions an optical axis of the laser 6A at a desired position on a printed circuit board 12A A scan area (that is, a processed area) 12A determined by rotation angles of the galvano mirrors 10Aa and 10Ab and a diameter of the fθ lens 11A has a size of about 50 mm×50 mm. A printed circuit board 13 including a copper layer as a workpiece and an insulating layer is fixed to an X-Y table 14. Note that the first processing head A and the second processing head B may process the printed circuit board 13 having the same pattern, or may process the printed circuit board 13 having different patterns. A control device 20 controls the laser oscillator 1, the beam diameter adjustment device 3, the driving devices of the plates 7A and 7B, the galvano mirrors 10Aa, 10Ab, 10Ba, and 10Bb, and an X-Y table 14A (including an X-Y table 14B in some cases) according to an input control program.

In a case of processing holes, the X-Y tables 14A and 14B are moved to cause the designated processing regions 12A and 12B to face the f lenses 11A and 11B, respectively, and then, first, holes are processed in all the copper layers in the processing regions 12A and 12B by one beam irradiation (that is, irradiation of one pulse), and then, the insulating laver is processed by one or more times of pulse irradiation to complete the holes in the processing regions 12A and 12B.

FIGS. 10A and 10B are diagrams illustrating a setting time of the galvano mirror and a laser irradiation time, in which a horizontal axis represents a time, FIG. 10A is a case of the processing head A, and FIG. 10B is a case of the processing head B.

Of the galvano mirrors 10Aa and 10Ab of the head A, the time when the positioning time becomes longer at a certain processing portion is referred to as a galvano time GA of the head A. and of the galvano mirrors 10Ba and 10Bb of the head B, the time when the positioning time becomes longer at a certain processing portion is referred to as a galvano time GB of the head B. L1 is one laser irradiation time.

When processing contents of a printed circuit board 13A and a printed circuit board 13B processed by the processing head A and the processing head B are the same and the galvano times GA and GB are the same, the laser 2 can be simultaneously supplied to the two processing heads. However, when the processing contents of the processing head A and the processing head B are different and the galvano times GA and GB are different, it is necessary to match the longer galvano time in order to simultaneously supply the laser 2 to the processing head A and the processing head B. That is, when GA1<GB1, and GA2>GB2, a waiting time of (GB1−GA1) occurs in the processing head A. and a waiting time of (GA2−GB2) occurs in the processing head B. Therefore, an overall processing efficiency is reduced.

In recent years, with the progress of thinning of a substrate, a case of processing a hole in an insulating layer having no copper layer on a surface as a substrate for a package is increasing. In such a case, a diameter of a hole processed is 60 μm or less, and an output required in processing is about 20 W.

Next, an actual processing example will be described.

FIG. 11 is a diagram illustrating a laser irradiation example in the related art, where a vertical axis represents an output and a horizontal axis represents a time. In addition, an upper part indicates on and off of an RF pulse (hereinafter, simply referred to as RF) for exciting a laser medium of the laser oscillator 1.

For example, in a case where a hole of 60 μm is processed in the insulating layer, after processing is performed by irradiating a laser according to an output curve A1 in which an output at an RF application time of 20 μs is 20 W, the laser under the same condition is irradiated again in the next pulse period. That is, the processing time in this case is 180 μs obtained by adding 80 μs (including 60 μs of the time until the laser disappears after RF stop) in which the laser continues in a second pulse period of 100 μs subsequent to the first pulse to a pulse period of 100 μs of a first pulse irradiated after positioning of the galvanometer mirror. Here, the reason why the laser can be continuously irradiated twice is that, unlike the case of processing a copper layer having a high processing threshold or processing an insulating layer having a thickness exceeding 60 μm after processing the copper layer, the insulating layer having a low processing threshold and a thickness of about 30 μm has a small amount of heat accumulated in the processed portion.

As illustrated in the figure, the output curve A1 has a first peak output (the duration of the output is short) immediately after RF application. The first peak output is about ½ of a second peak output at a rated RF application time (20 μs in this case). After RF application is stopped, the energy accumulated in the laser medium in the laser oscillator is output as a laser. In the figure, the duration of the laser based on the laser medium in the laser oscillator is about 60 μs.

However, in the above processing, the following problems occur.

(1) Due to an influence of the first peak output, a diameter of an inlet portion of a processed hole may increase by 2 to 3 μm.
(2) The diameter of the processed hole varies with an output variation of the laser.

Here, the output variation of the laser will be described with reference to the drawings.

FIGS. 12A and 12B are diagrams illustrating output variation of the second peak output, in which FIG. 12A illustrates a case where a pulse frequency is 1 to 5 kHz, and FIG. 12B illustrates a case where the pulse frequency is 1 to 10 kHz, respectively. For example, when intervals of the holes to be processed are substantially the same, the second peak output hardly varies. However, the interval between the holes to be processed is determined by an interval between the mounted products mounted on the printed circuit board and a position of the hole coupled to a lower copper layer, and thus is not uniform. As a result, the output accumulated in the laser medium changes due to a change in a laser excitation interval (that is, a duty). Then, as illustrated in FIG. 12A, the output changes by about +3% when the frequency is 1 to 5 kHz, and as illustrated in FIG. 12B, the output changes by about ±5% when the frequency is 1 to 10 kHz. Therefore, the diameter of the processed hole varies.

(3) Even during an RF stop period subsequent to the RF application time of 20 μs, the processed portion is irradiated with the energy accumulated in the laser medium for about 60 μs after the RF is stopped, so that a temperature of the processed portion increases. Even when a temperature rise value of the processed portion is lower than a processing threshold of the insulating layer, if this period continues for 10 μs or more, the insulating layer of a hole bottom and a hole wall surface is easily carbonized, and a processing quality of the hole is deteriorated.

As described above, it is desired to make a diameter of a hole to be processed uniform and to prevent deterioration in a quality of an insulating laver.

### SUMMARY OF THE INVENTION

According to a first aspect of the present invention, a laser processing method for performing laser processing on a printed circuit board by using a carbon dioxide laser oscillator that oscillates a laser by applying an RF pulse includes continuing laser oscillation by restarting RF pulse application while a laser after completing the RF pulse application is output, cutting off the continuously oscillated laser for a desired time, and performing laser processing on the printed circuit board.

According to a second aspect of the present invention, a laser processing machine includes a carbon dioxide laser oscillator configured to oscillate a laser by applying an RF pulse, a laser cutting unit configured to temporally cut off the laser oscillated from the carbon dioxide laser oscillator and selectively supply the laser to a processed portion of a printed circuit board, and a control device configured to control the carbon dioxide laser oscillator and the laser cutting unit, in which the control device continues laser oscillation from the carbon dioxide laser oscillator by restarting RF pulse application while the laser after completing the RF pulse application is output, and cuts off the continuously oscillated laser for a desired time by the laser cutting unit and supplies the laser to the processed portion.

Further features and advantages of the present invention will become apparent from the following description of exemplary embodiments with reference to the attached drawings.

### BRIEF DESCRIPTION OF THE DRAWINGS

FIG. 1 is a diagram illustrating elements of a sawtooth wave according to the present invention.

FIG. 2 is an example of an output waveform.

FIG. 3 is a diagram illustrating a sawtooth wave generation procedure according to the present invention.

FIG. 4 is a diagram illustrating a processing example using a rectangular wave pulse of a sawtooth n.

FIG. 5A is a diagram illustrating an energy space distribution of an output according to the present embodiment.

FIG. 5B is a diagram illustrating an energy space distribution of an output of the related art.

FIG. 6 is a configuration diagram of a two-head laser processing machine according to the present invention.

FIG. 7A is a diagram illustrating a setting time of a galvano mirror and a laser irradiation time in a case of a processing head A.

FIG. 7B is a diagram illustrating a setting time of a galvano mirror and a laser irradiation time in a case of a processing head B.

FIG. 8A is an explanatory diagram of a rectangular wave pulse in a case of processing an insulating layer containing a filler.

FIG. 8B is an explanatory diagram of a rectangular wave pulse in a case of processing an insulating layer containing a filler.

FIG. 8C is an explanatory diagram of a rectangular wave pulse in a case of processing an insulating layer containing a filler.

FIG. 8D is an explanatory diagram of a rectangular wave pulse in a case of processing an insulating layer containing a filler.

FIG. 9 is a configuration diagram of a two-head laser processing machine in the related art.

FIG. 10A is a diagram illustrating a setting time of a galvano mirror and a laser irradiation time.

FIG. 10B is a diagram illustrating a setting time of a galvano mirror and a laser irradiation time.

FIG. 11 is a diagram illustrating a laser irradiation example in the related art.

FIG. 12A is a diagram illustrating an output variation of a second peak output in a case where a pulse frequency is 1 to 5 kHz.

FIG. 12B is a diagram illustrating an output variation of a second peak output in a case where a pulse frequency is 1 to 10 kHz.

### DESCRIPTION OF THE EMBODIMENTS

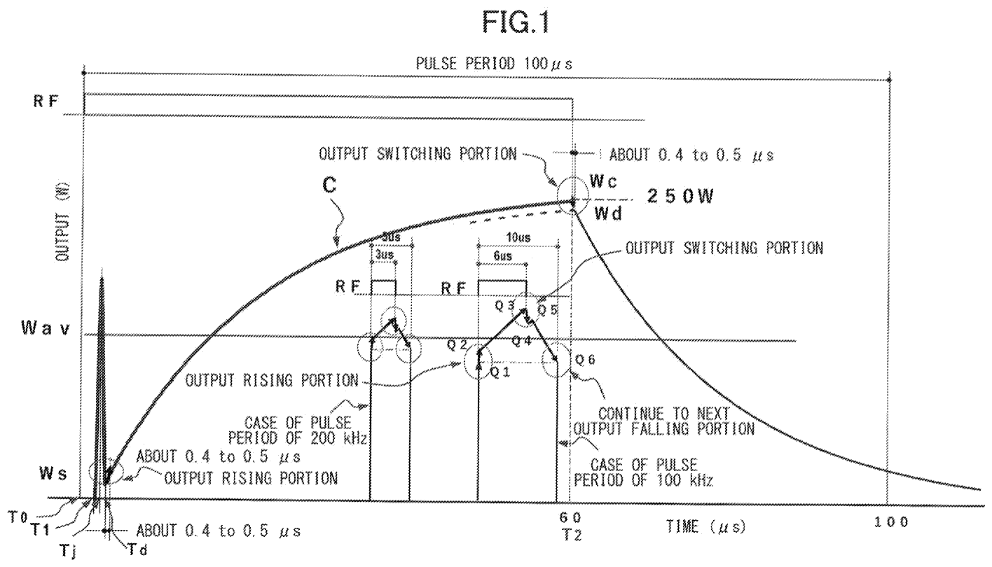

FIG. 1 is a diagram illustrating elements of a sawtooth wave according to the present invention. Note that an output curve C (fundamental wave pulse waveform) in the drawing is an output curve of a rated duty of 60% (RF application time/pulse period. Hereinafter, the “rated duty” is simply referred to as “Dty”.), a pulse period of 10 KHz, and a maximum output of 250 W, where a vertical axis represents an output of a laser oscillated, and a horizontal axis represents a time. An upper part indicates on and off of the RF for exciting a laser medium of a laser oscillator 1.

First, the output curve C will be described. When the RF is turned on at time T0, the laser is explosively output at time T1, and reaches a first peak output Wj at time Tj, then attenuates to time Td, then increases again, and reaches a second peak output of 250 W at time T2 when the RF application time of 60 μs has elapsed from time T0. Here, the output indicated by a solid line in an RF application period is a sum of an output of the transition to a CO₂ gas through an N₂ gas as the laser medium by the RF (the output indicated by a dotted line in a vicinity of 60 μs in the drawing) and an output at which the CO₂ gas is directly excited by the RF (that is, the output between the output shown by the dotted line and the output shown by the solid line). Therefore, when the RF application is stopped, the output at which the CO₂ gas is directly excited by the RF becomes 0, and after time T2, the energy accumulated in the N₂ gas which is the laser medium in the laser oscillator is output as a laser. The energy accumulated in the laser medium is output for about 60 μs after time T2.

The present inventor has confirmed the following requirements through experiments and simulations.

### 1. Requirement 1

For example, when the RF is applied with Dty of 60% (pulse width of 60 μs) and a pulse period of 10 kHz, the output of the oscillated laser gradually increases to a maximum at a pulse width of 60 μs, as indicated in the output curve C. Then, when the RF application is stopped, the output is attenuated. Then, in a case where the laser is oscillated within a Dty range of the laser oscillator, the output rises along the same output curve (illustrated output curve C) even when the RF application time changes. That is, in a case of oscillation at Dty of 40% (pulse width of 40 μs) and 10 kHz, the output rises following the output curve C, becomes maximum at the pulse width of 40 μs, and is attenuated similarly to the above case. Also in a case where oscillation is performed at Dty of 20% (pulse width 20 μs) and 10 kHz, the output rises along the output curve C, becomes maximum at a pulse width of 20 μs, and is attenuated similarly to the above case.

### 2. Requirement 2

In a case of a CO₂ laser, when the RF application is started at time T0, oscillation of the laser is started by the excitation output accumulated in the laser medium at time T1, the output rapidly increases to reach a first peak output Wj at time Tj, and then attenuates once (time Td) and thereafter, the output increases again to reach a second peak output when the RF application is stopped.

In this case, time Td is 0.4 to 0.5 μs from time T0, and it has been found that an output response (output change per unit time) Ws at time Td is substantially constant even if Dty and the pulse width change.

### 3. Requirement 3

When the RF application is stopped, the output switches from 250 W to a residual output stored in the laser medium. A switching time is 0.4 to 0.5 μs, and the output is once decreased, then slightly increased, and then attenuated. Hereinafter, an output response at the time of output switching is referred to as an output response Wc, and an output response when the output rises slightly is referred to as an output response Wd.

Then, it was found that the output response We has a value that hardly changes even if Dty and the pulse width change. Note that the output response We and the above-described output response Ws have different output directions from each other, but magnitudes of output components are almost the same.

### 4. Requirement 4

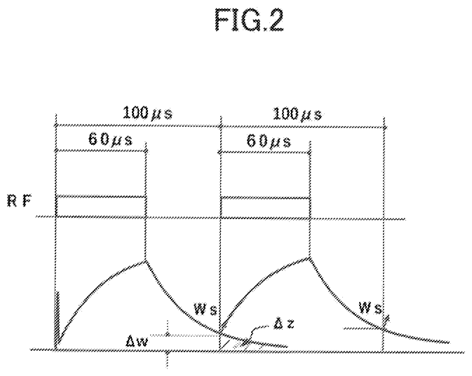

FIG. 2 is an example of an output waveform, which is an output waveform when the energy accumulated in the laser medium resumes RF application at an end point of the pulse period. As shown in the figure, in a case where there is a residual output (Δz that is indicated by hatching in the drawing) accumulated in the laser medium at the start of RF application, and the output at the start of RF application is ΔW. Here, ΔW>0) accumulated in the laser medium at the start of RF application, when excitation of the next (second) pulse period is started, the excited output is superimposed on the residual output, and the output increases in the output response Ws after 0.4 to 0.5 μs, but at this time, the first peak output Wj does not occur. Note that, although a connection between the first pulse period and the second pulse period has been described here, when repeated up to the n-th pulse period, a level of the output at which the output response Ws is generated gradually increases, while the second peak output gradually decreases, but stabilizes in about 1 second.

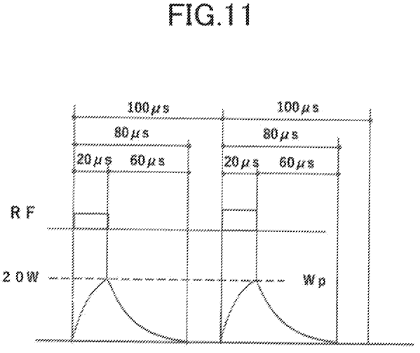

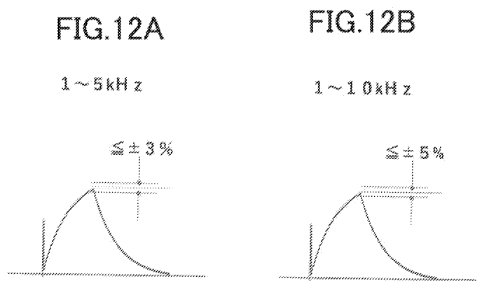

Here, in the case of FIG. 11, since the residual energy accumulated in the laser medium before the second pulse period is started is 0, the output curve of the second pulse period is the same as the output curve of the first pulse period.

Here, a value obtained by dividing an integral value (that is, the total output that is output at the pulse period of 0 to 100 μs) of the output continuously oscillated at Dty 60% in the output curve C by a pulse period of 100 μs is referred to as average output Wav.

Note that, in a case where Dty is constant, the average output Way illustrated in FIG. 1 hardly changes in a range where the pulse period is 20 to 200 KHz. On the other hand, when the pulse frequency is made constant, the average output Way increases in proportion to Dty. In addition, a tangential output response Wr at the average output of the output curve C during an RF-on period and a tangential output response Wf at the average output of the output curve C during an RF-off period have values unique to the average output.

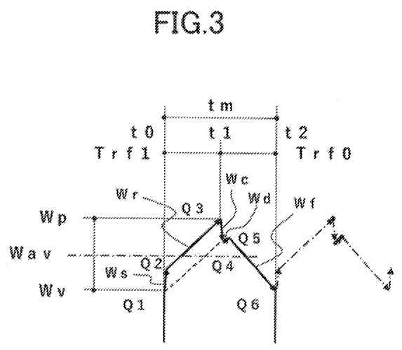

In FIG. 1, sawtooth waves of 100 kHz and 200 kHz are described, but the details will be described with reference to FIG. 3.

FIG. 3 is a diagram illustrating a sawtooth wave generation procedure according to the present invention.

When Dty=Trf1/tm (here, tm is a pulse period, and includes an RF application period Trf1 and an RF application stop period Trf0) is set in the output curve C, the average output Way is determined. Even if the pulse period tm is shortened, if a ratio between the RF application time Trf1 and the RF application stop time Trf0 is the same, Dty is the same, and the average output Way hardly changes. Therefore, the sawtooth wave according to the present invention is generated based on the fundamental wave pulse waveform (the above-described output curve C) and the above-described requirements 1 to 4.

The sawtooth wave generation procedure is as follows.

Procedure 1) With a vertical axis as an output axis, Dty, the pulse period tm, the average output Wav, an upper limit output Wp. and a lower limit output Wv are set. Here, the upper limit output Wp is an output level [J/s] at which a target hole diameter is obtained by the irradiated pulse, and is set to a value corresponding to a threshold of a material. In addition, the lower limit output Wv is an output level at the rise time of the output response Ws when the RF is turned on in the sawtooth pulse in which the continuous oscillation is stable.
Procedure 2) With a horizontal axis as a time axis, a point on the lower limit output Wv at time t0 is Q1, and a point on the lower limit output Wv at time t2 that is the pulse period is Q6. Then, the output response Ws starting from the point Q1 is plotted, and an end point of the output response Ws is set as a point Q2.
Procedure 3) The point Q2 and the point Q3 on the upper limit output Wp at the time t1 are connected by the output response Wr. Note that time t1 is an end point of the RF application period Trf1 (a start point of the RF application stop period Trf0).
Procedure 4) The output response Wc is plotted with the point Q3 as a start point, and an end point of the output response Wc is set as a point Q4.
Procedure 5) A small output response Wd is plotted on an extension line connecting the point Q1 and the point Q4, and an end point of the output response Wd is set as a point Q5.
Procedure 6) The point Q5 and the point Q6 are connected by an output line segment Wf. Tat is, the point Q5 is an intersection of an extension line connecting the point Q1 and the point Q4 and the output response Wf having the point Q6 as an end point.

Through the above procedure, the sawtooth wave added to the lower limit output Wv is completed.

Hereinafter, the sawtooth-shaped pulse in which a polygon formed in the above procedure is superimposed on the lower limit output Wv is referred to as a “sawtooth pulse”.

Note that, as described in paragraph 0020, the output of the laser oscillator is in a stable state when exceeding 1 second, and as long as the laser oscillator is in an operating state, a variation range of the average output Way and the upper limit output Wp is about 1%.

In addition, as illustrated in the drawing, assuming that the point Q1 and the point Q4 are connected by a dotted line, the output surrounded by the quadrangle of Q1, Q2, Q3, and Q4 corresponds to the output at which the CO₂ gas is directly excited by the RF described in paragraph 0016.

Here, FIG. 1 illustrates one sawtooth pulse of 100 KHz and one sawtooth pulse of 200 KHz created in the above procedure.

Here, in a case where Dty is constant and the pulse period tm is changed, the output responses Ws and We do not change. On the other hand, the output responses Wr. Wd, and Wf change according to the pulse period tm, but the average output Way hardly changes. In addition, in a case where the pulse period tm is constant and Dty is changed, the output responses Ws and Wc are hardly changed, and the output responses Wr, Wd, and Wf are changed. In this case, when Dty decreases, increase rates (rising) of the output responses Wr and Wd become steep, and a decrease rate (falling) of the output response Wf becomes gentle. On the other hand, when Dty increases, the increase rates (rising) of the output responses Wr and Wd become gentle, and the decrease rate (falling) of the output response Wf becomes steep. The average output varies depending on Dty, but is determined as a unique value.

Therefore, the waveform and output of the sawtooth pulse can be controlled by setting the pulse period tm, the RF application time Trf1, and the RF application stop time Trf0 within the Dty range. In the actual processing, the waveform generation process described above is continuously performed, and n sawtooth pulses (n is an integer of 1 or more) are formed. Hereinafter, the pulses including n sawtooth pulses supplied during processing are collectively referred to as “a rectangular wave pulse of a sawtooth n”.

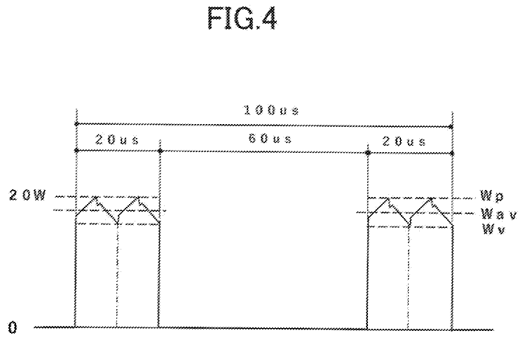

FIG. 4 is a diagram illustrating a processing example using a rectangular wave pulse of a sawtooth n, where a vertical axis represents output and a horizontal axis represents a time.

Here, assuming that the hole to be processed is the same hole as described above with reference to FIG. 11, since processing is performed with two pulses with a pulse frequency of 10 kHz in the case of the related art, the laser irradiation time was 20 μs twice, and the processing time was 180 μs obtained by adding a pulse period of 100 μs of a first pulse, an RF application time of 20 μs of a second pulse, and a non-excitation time of 60 μs. On the other hand, in the case of the present application, in a case where processing is performed by irradiating a rectangular wave pulse of a sawtooth 2 having a pulse frequency of 100 kHz, which provides pulse energy equivalent to that in the related art, twice, since the processing is not affected by the pulse period, an interval between two rectangular pulses can be arbitrarily set. Assuming that the interval between the rectangular wave pulses of two sawteeth 2 is 60 μs, the processing time is 100 μs. Therefore, according to the present application, the processing time can be shortened by 80 μs as compared with the case in the related art.

Next, the present application and the related art will be described with reference to a shape of a processed hole.

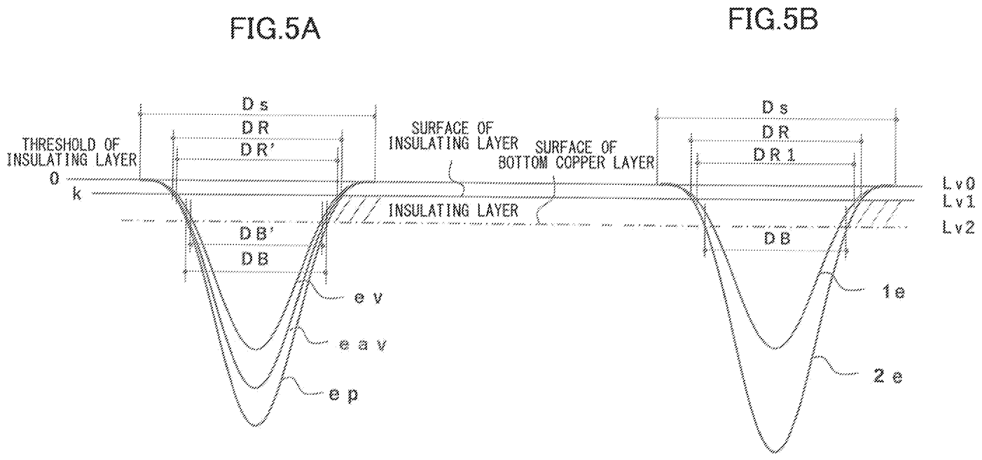

FIGS. 5A and 5B are diagrams illustrating energy space distribution of the output, FIG. 5A is a case of the present application, FIG. 5B is a case of the related art, a vertical axis represents a normalized energy level and a processing depth, and a horizontal axis represents a radial direction of a hole. Ds in FIGS. 5A and 5B indicates a beam spot diameter of the processed portion, DR indicates a target hole diameter. DR1 and DR′ indicate hole diameters smaller than DR, and DB and DB′ indicate hole bottom diameters, respectively. In addition, Lv0 indicates a position of energy level 0, Lv1 indicates a surface position of an insulating layer, Lv2 indicates a bottom surface position of the insulating layer, and k indicates a processing threshold of the insulating layer.

Further, ep indicates an energy distribution at the time of the output Wp, ev indicates an energy distribution at the time of the output Wv, eav indicates an energy distribution at the time of the average output Way, 1e indicates an energy distribution of the first pulse, and 2e indicates an energy distribution of the second pulse, respectively. Note that the output Wp, the output Wv, and the average output Way are as indicated in FIG. 3.

The following description will be made in correspondence with the radial direction of the hole processed by the processing process of the present application. Note that an energy distribution when a processing diameter increases in the RF application period Trf1 is referred to as a diameter increase energy distribution, and an energy distribution when a processing diameter decreases in the RF application stop period Trf0 is referred to as a diameter decrease energy distribution. The processing is started with an output response Ws with an output rise of about 0.4 μs superimposed on the output Wv at the same time as the RF application, and then processed with a processing diameter increase energy distribution of the output response Ws, and the target hole inlet diameter is formed when the time Trf1 elapses. At the same time as stopping the Rf application, processing is further performed according to the output response We of a processing diameter decrease energy distribution, a processing diameter fine increase output response Wd, and a processing diameter decrease energy distribution output response Wf.

In the above processing process, processing is alternately performed with the spot diameters DR and DB and DR′ and DB′. The output rise at the start of processing is steeper than that in the pulse of the related art, and the irradiation time is short. In addition, since the energy distribution diameter after stopping the RF application is reduced and separated from a hole inlet and a hole side wall, heat conduction to the hole inlet and the hole side wall surface at the time of processing the insulating layer is reduced. As a result, a thermal influence of the insulating layer on the hole wall surface is reduced, and a hole quality is improved. Furthermore, since processing is performed with continuous sawtooth pulses, laser irradiation is not performed after stopping RF application that is not involved in processing as in the related art. Therefore, the quality of the hole inlet and the hole side wall surface is not deteriorated. In addition, since it is not affected by the first peak output, the diameter of the hole inlet does not increase.

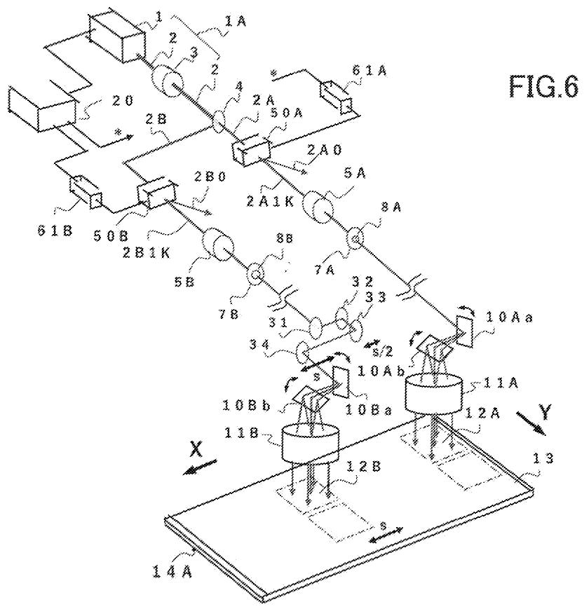

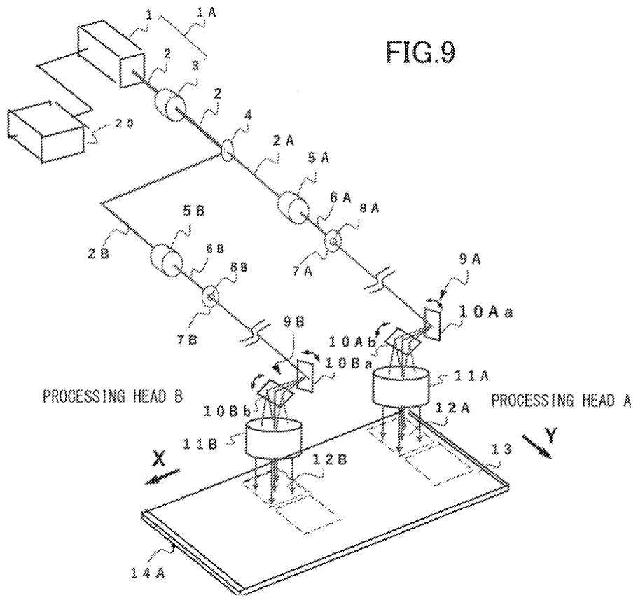

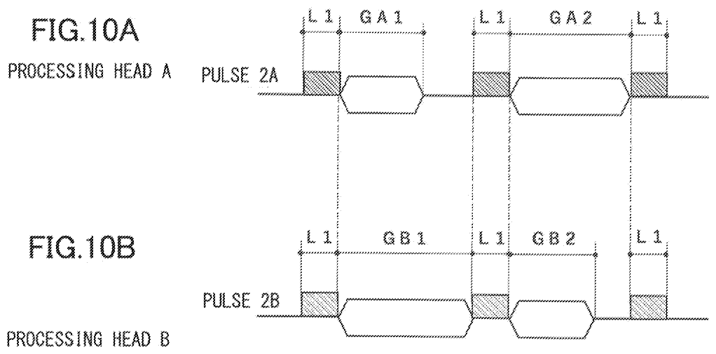

FIG. 6 is a configuration diagram of a two-head laser processing machine according to the present embodiment, and the same reference numerals are given to the same objects or objects having the same functions as those in FIG. 9, and a detailed description thereof will be omitted.

The laser oscillator 1 outputs a continuous linearly polarized sawtooth laser 2 having a frequency of 50 kHz or more by setting an application time and a pause time of a high frequency RF for driving laser oscillation. A beam diameter adjustment device 3 disposed between the laser oscillator 1 and a beam splitter 4 is a device for adjusting an energy density of the laser 2, and adjusts the energy density of the laser 2 by changing an outer diameter of the laser 2 output from the laser oscillator 1. That is, the energy of the laser 2 before and after the beam diameter adjustment device 3 does not change. Therefore, since the laser 2 emitted from the beam diameter adjustment device 3 can be regarded as the laser 2 output from the laser oscillator 1, hereinafter, the laser oscillator 1 and the beam diameter adjustment device 3 are collectively referred to as a laser output device 1A. The beam diameter adjustment device 3 may not be used.

An acousto optics modulator (AOM) 50A driven by a driver 61A is disposed between the beam splitter 4 and the polarization conversion device 5A. The AOM 50A branches the laser 2A into a laser 2A1K of first-order light and a laser 2A0 of 0th-order light, and adjusts an output of the laser 2A1K used for processing by changing a branching ratio (opening degree). The laser 2A0 not used for processing is discarded in a damper (not illustrated) so as not to be diffused to a periphery.

The laser processing machine is configured such that the second head B can be positioned in an X direction with respect to the fixed first head A by a moving device of a second head B (not illustrated), and a position of the second head B is configured to be widened by a maximum of S with respect to the first head A. A mirror 31 and a mirror 34 are fixed at predetermined positions, and mirrors 32 and 33 are supported by a mirror moving device (not illustrated) and can be positioned in the X direction. Note that the mirrors 31 to 34 are disposed such that an axis of an aperture 8B coincides with a center of the galvano mirror 10Ba regardless of the positions of the mirrors 32 and 33 in the X direction. The control device 20 controls the laser oscillator 1, the beam diameter adjustment device 3, the drivers 61A and 61B of the AOM, the driving devices of the plates 7A and 7B, the galvano mirrors 10Aa, 10Ab, 10Ba. and 10Bb, the X-Y table 14A (including the X-Y table 14B in some cases), the moving device of the second head B. and the mirror moving device (not illustrated).

In the present embodiment, the AOM 50A described above is a first laser cutting unit configured to temporally cut off the laser distributed toward the processing head A as the first processing head by the beam splitter 4 and selectively supply the laser to the processing head A. In the present embodiment, the AOM 50B is disposed between the beam splitter 4 and the polarization conversion device 5B, and the AOM 50B is a second laser cutting unit configured to temporally cut off the laser distributed toward the processing head B as the second processing head by the beam splitter 4 and selectively supply the laser to the processing head B. In addition, each of the AOMs 50A and 50B can also be said to be a laser cutting unit that temporally cuts off the laser oscillated from the laser oscillator 1 and selectively supplies the laser to the processed portion of the printed circuit board. In the present embodiment, the laser cutting unit is configured by using the AOM, but the present invention is not limited thereto, and for example, the laser cutting units 5A and 5B may be configured by using an electro-optic modulator (EOM) or the like.

Hereinafter, a processing procedure will be described. Note that the processing content differs for each head, but the operation is substantially the same, and thus the case of the first head A will be described.

When the processing start command is given, the control device 20 drives the moving device of the second head B to move the second head B to the designated position. Next, the X-Y table is controlled to position the first head A at the processing position, and the galvano mirrors 10Aa and 10Ab are positioned at a first processing position to stand by. In addition, the moving device of the second head B (not illustrated) is operated to move the second head B by a distance s with respect to the first head A Thereafter, a mirror moving device (not illustrated) is operated to move the position of the mirror 32 by a distance s/2 in a moving direction of the head 2. As a result, since the distance between the aperture 8B and the galvano mirror 10Ba is always constant, a size of the image of the aperture 8 can be always kept constant regardless of the position of the second head B.

First, the laser oscillator 1 is operated, and after a predetermined waiting time elapses, a processing program is started to start processing. Here, the reason for providing the waiting time is that the output of the laser oscillator 1 becomes unstable until reaching a thermal equilibrium state, and the time is about 1 to 2 seconds.

When the waiting time elapses, the control device 20 causes the laser oscillator 1 to output the laser 2 shaped in a sawtooth shape (hereinafter, it is simply referred to as a laser 2) according to a processing program input in advance. A diameter of the laser 2 is changed by the beam diameter adjustment device 3, and the laser 2 is divided into the laser 2A by the beam splitter 4 and incident on the AOM 50. The AOM 50 discards the laser 2A in the damper until receiving an operation command from the control device 20. Upon receiving a positioning completion signal of one of the galvano mirrors 10Aa and 10Ab that is positioned later, the control device 20 operates the AOM 50A via the driver 61A to output the laser 2A as a rectangular wave pulse 2A1K including n sawtooth pulses attenuated to a predetermined output. The rectangular wave pulse 2A1K is positioned by galvano mirrors 10Aa and 10Ab, and is incident on a designated position of a printed circuit board 13A to make a hole in the printed circuit board 13A Hereinafter, as in the case in the related art, the above-described operation for making hole is repeated until the designated processing is completed. In the above processing, the laser oscillator 1 turns on and off the RF at a period and a pulse period designated in advance, thereby continuously outputting the laser 2 from the start to the end of the processing.

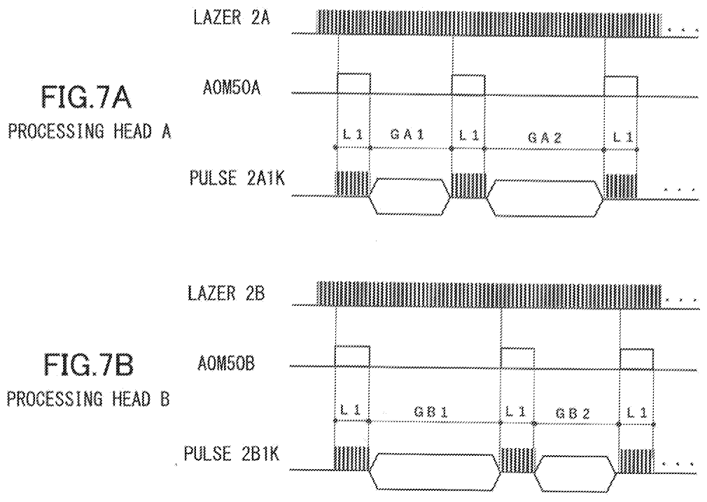

FIGS. 7A and 7B are diagrams illustrating a setting time of the galvano mirror and a laser irradiation time in the present invention. FIG. 7A illustrates a case of the processing head A, and FIG. 7B illustrates a case of the processing head B, respectively. A horizontal axis in the drawing represents a time.

As illustrated in the drawing, the lasers 2A and 2B including the sawtooth pulses are constantly output during processing, and in the case of the first head A, when the galvano time GA1 or GA2 is completed, the AOM 50 irradiates the processed portion on the printed circuit board with the rectangular wave pulse 2A1K including the required n sawtooth pulses to make a hole. In this case, the first head A continues the operation without considering the galvano times GB1 and GB2 of the second head B. Similarly, the second head B continues the operation without considering the galvano times GA1 and GA2 of the first head A. As a result, a waiting time does not occur in each head, and a processing efficiency can be improved by 20 to 30% as compared with the related art. When the positioning of the galvano mirror is completed according to a clock of the device (not illustrated), the AOM 50 is controlled so that the output matches the RF application start time of a first sawtooth pulse so that the rectangular wave pulse of the sawtooth n supplied to the processed portion is not lost or missing.

Next, the configuration of the sawtooth according to the present embodiment will be described in more detail.

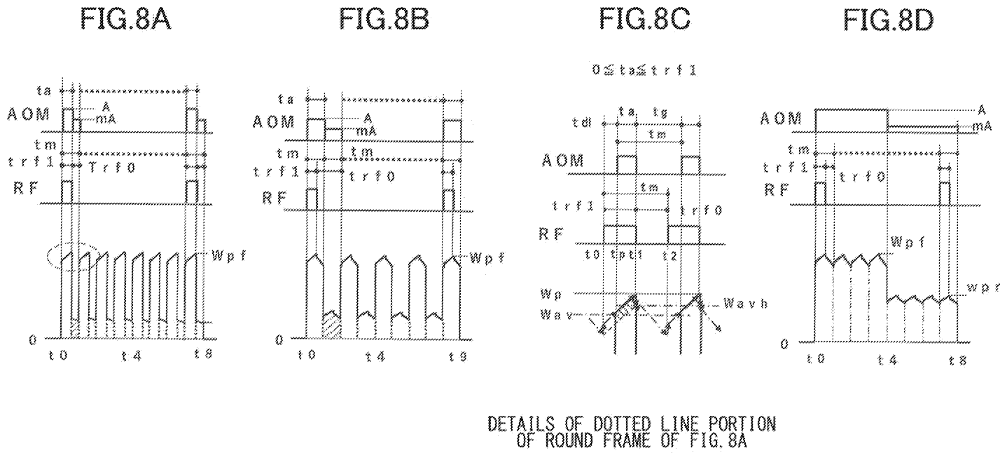

FIGS. 8A to 8D are explanatory diagrams of rectangular wave pulses in a case of processing an insulating layer containing a reinforcement (for example, a filler), in which a horizontal axis represents a time, and t0 to tn9 are times based on t0. In addition, TH is a rectangular wave pulse of one sawtooth n.

Here, an upper part indicates the operation of the AOM, where A is an opening degree of the AOM of 100%, and mA is an opening degree of the AOM of m %. In addition, a middle part indicates on/off of the RF tm is a pulse period, trf1 is an on time of the RF, and Trf0 is an off time of the RF. In addition, a lower part is an output, Wpf in the drawing is an upper limit output at which a filler of the insulating layer can be processed, and Wpr is an upper limit output at which a resin of the insulating layer can be processed.

In the case of FIG. 8A, the filler is mainly processed by increasing a laser diameter during an RM-ON period, and a gas and a processing waste generated by the processing can be quickly removed from the processed portion by decreasing the laser diameter during an RM-OFF period, so that a processing quality of a hole wall surface and a hole bottom is improved. In addition, in the case of FIG. 8B, as in the case of FIG. 8A, the gas and the processing waste generated by the processing can be quickly removed from the processed portion, so that the processing quality of the hole wall surface and the hole bottom is improved.

FIG. 8C is a modification of a portion surrounded by the dotted line in FIG. 8A, and is a waveform control example in which the AOM is turned on for a time ta from the middle of the output rising of the RM-ON period in FIG. 8A (time td1 in FIG. 8A). In this way, as a result of processing with a high average output Wavh of the output rising portion, the hole inlet portion and the hole sidewall become uniform, and the hole quality is improved.

Further, FIG. 8D is adopted, for example, when it is desired to incline the hole in a depth direction.

Next, a processing example will be described.

The rectangular wave pulse of the sawtooth n illustrated in FIGS. 8A to 8C and the pulse in the related art of FIG. 11 are applied, and the processing is performed on the filler-containing insulating layer for package (ABF by Ajinomoto (Ajinomoto Build-up Film), material thickness of about 30 μm) at a processing spot of 60 μm having the same diameter. The results are as follows. Note that this drawing illustrates the shape of the sawtooth pulse, and does not illustrate the rectangular wave pulse of the sawtooth n used for processing.

In the case of FIG. 8A, when a rectangular wave pulse of two sawteeth 3 with a frequency of 100 kHz, Dty 60% (trf1=6 μs, trf0=4 μs), Wpf=20 W, the period trf1 has an AOM opening degree of 100%, and the period trf1 has an AOM opening degree of 0%, the hole inlet diameter was about 62 μm, and the hole (bottom diameter/inlet diameter) ratio was about 80%. When the AOM opening degree is 0%, the output of the hatched portion in FIG. 8A is 0.

In the case of FIG. 8B, when a rectangular wave pulse of two sawteeth 3 with a frequency of 100 KHz, Dty 60% (trf1=6 μs, trf0=4 μs), Wpf=20 W, an AOM opening degree of a first sawtooth of 100%, an AOM opening degree of a second sawtooth of 0%, and an AOM opening degree of a third sawtooth of 100%, the hole inlet diameter was about 60 μm, and the hole (bottom diameter/inlet diameter) ratio was about 80%.

In the case of FIG. 8C, a rectangular wave pulse of two sawteeth 3 with a frequency of 100 KHz, Dty 60%, td1=6 μs with an AOM opening degree of 0%, and ta=4 μs with an AOM opening degree of 100%, the hole inlet diameter was about 60 μm, and the hole (bottom diameter/inlet diameter) ratio was about 81%.

In the cases of FIGS. 8A, 8B, and 8C, there was almost no carbonization of the resin on the surface of the copper layer of the hole bottom.

Incidentally, when processing was performed at a pulse width of 20 μs, a pulse frequency of 10 kHz. and a pulse number of 4 according to the related art illustrated in FIG. 11, the hole inlet diameter was about 63 μm, and the hole (bottom diameter/inlet diameter) ratio was about 78%. In addition, the adhesion of carbonized resin was observed on the copper surface at the hole bottom. In addition, when processing is performed by increasing the output in a pulse in which the first peak output Wj is higher than the second peak output WP, the hole inlet diameter was about 65 μm due to diffracted light of the first peak output Wj, and a periphery of the hole inlet was damaged in a ring shape.

Further, optimum values of the output responses Ws, Wc, Wr, Wd, and Wf are different depending on a material of a workpiece. Therefore, the processing quality and the processing speed can be improved by setting the values of the output responses Ws, Wc, Wr, Wd, and Wf to the optimum values according to the material of the workpiece.

In actual processing, the values of the output levels Wp and Wv and the values of the output responses Ws, Wc, Wr, Wd. and Wf are known in advance for each workpiece. In addition, the maximum output of the laser oscillator when the rated duty and the pulse period are determined is also known in advance. Furthermore, an aperture diameter suitable for the hole diameter to be processed is also known.

Therefore, in the case of processing the material for the first time, for example, first, the values of the levels Wp and Wv are tentatively determined with reference to the data in the related art, and the output level Wp is increased or decreased by comparing the hole diameter processed by the test with the target hole diameter. Next, processing is performed with a sawtooth pulse n, and a value of n is determined by a depth of the processed hole. At this time, when n increases, quality degradation due to heat of the insulating layer occurs. Therefore, when the number of n increases, n is divided to adopt rectangular wave pulses of a plurality of sawteeth m, and a period for cooling the processed portion is provided between the rectangular wave pulses.

In the two-head laser processing machine illustrated in FIG. 6, when the output of the laser oscillator 1 is 250 W, since the average output is 125 W, it is divided by the beam splitter 4 and 62.5 W is supplied to each head. Therefore, as described in paragraph 0033, when Wpf=20 W, both the heads A and B can be processed. However, for example, when a resin with a carrier PET film is processed, it is required to set Wpf to 70 W. Therefore, when it is required to set Wpf to 70 W, the output of the laser oscillator 1 in FIG. 6 needs to be set to, for example, 500 W.

Furthermore, the laser oscillator in which the first peak output immediately after the RF application has an output characteristic of the fundamental wave pulse waveform (output curve C and output curve A1) smaller than the second peak output at the time of stopping the RF application has been described above as an example, but the present application can also be applied to a laser oscillator in which the first peak output immediately after the RF application has an output characteristic of the fundamental wave pulse waveform larger than the second peak output at the time of stopping the RF application.

As described above, in the present embodiment, the hole diameter of the hole to be processed can be made uniform. In particular, a blind hole can be suitably formed in a filler-containing insulating layer formed of an ABF material built up on a copper layer, an ABF material with polyethylene terephthalate (PET), or the like. In addition, not only the quality of the hole wall surface can be improved, but also a processing efficiency can be improved. Further, since a stable laser is continuously oscillated, when the laser is supplied to the plurality of heads, the required laser can be supplied to any head independently of the other heads, so that the processing efficiency as the laser processing machine can be improved. For example, when the positioning of the processing head A is completed, the control device 20 controls the AOM 50A to supply a laser to the processing head A without considering the positioning state of the processing head B.

Note that the inventions described in the above-described embodiments may be combined in any manner. In addition, in the embodiment described above, the example of supplying the laser to the two processing heads has been described, but the present invention is not limited thereto, and the laser may be supplied to two or more processing heads, and the laser may be supplied to each processing head by cutting off the time by a laser cutting unit corresponding to each processing head.

### Other Embodiments

Embodiments of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s). Embodiments of the present invention can also be realized by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2021-76798, filed Mar. 12, 2021, and Japanese Patent Application filed Feb. 21, 2022 with reference No. AK00007 which are hereby incorporated by reference herein in their entirety.

What is claimed is:

1. A laser processing method for performing laser processing on a printed circuit board by using a carbon dioxide laser oscillator that oscillates a laser by applying an RF pulse, the method comprising:
continuing laser oscillation by restarting RF pulse application while a laser after completing the RF pulse application is output, cutting off the continuously oscillated laser for a desired time, and performing laser processing on the printed circuit board.

2. The laser processing method according to claim 1, further comprising:
generating a sawtooth pulse by controlling an application time of the RF pulse and an off time of the RF pulse, and processing with the generated sawtooth pulse.

3. The laser processing method according to claim 2, further comprising:
controlling at least one of a sum of the application time of the RF pulse and the off time of the RF pulse or a ratio of the application time of the RF pulse and the off time of the RF pulse.

4. A laser processing machine comprising:
a carbon dioxide laser oscillator configured to oscillate a laser by applying an RF pulse;
a laser cutting unit configured to temporally cut off the laser oscillated from the carbon dioxide laser oscillator and selectively supply the laser to a processed portion of a printed circuit board; and
a control device configured to control the carbon dioxide laser oscillator and the laser cutting unit, wherein
the control device continues laser oscillation from the carbon dioxide laser oscillator by restarting RF pulse application while a laser after completing the RF pulse application is output, and cuts off the continuously oscillated laser for a desired time by the laser cutting unit and supplies the laser to the processed portion.

5. The laser processing machine according to claim 4, further comprising:
a first and a second processing heads;
a beam splitter configured to distribute the laser oscillated from the carbon dioxide laser oscillator toward the first and second processing heads; and
a second laser cutting unit, wherein
the laser cutting unit is a first laser cutting unit configured to temporally cut off the laser distributed toward the first processing head by the beam splitter and selectively supply the laser to the first processing head,
the second laser cutting unit is configured to temporally cut off the laser distributed toward the second processing head by the beam splitter and selectively supply the laser to the second processing head, and
the control device controls the first laser cutting unit to supply the laser to the first processing head without considering a positioning state of the second processing head in a case where positioning of the first processing head is completed.
